(19) United States
(12) Patent Application Publication
(10) Pub. No.: US 2024/0281256 A1
(43) Pub. Date: Aug. 22, 2024

(54) Multi-core Acceleration of Neural Rendering

(71) Applicant: SHANGHAITECH UNIVERSITY, Shanghai (CN)

(72) Inventors: Yuhan GU, Shanghai (CN); Chaolin RAO, Shanghai (CN); Minye WU, Shanghai (CN); Xin LOU, Shanghai (CN); Pingqiang ZHOU, Shanghai (CN); Jingyi YU, Shanghai (CN)

(73) Assignee: SHANGHAITECH UNIVERSITY, Shanghai (CN)

(21) Appl. No.: 18/646,818

(22) Filed: Apr. 26, 2024

Related U.S. Application Data
(63) Continuation of application No. PCT/CN2021/136922, filed on Dec. 9, 2021.

(51) Int. Cl. G06F 9/38; G06T 1/20; G06T 15/00

(52) U.S. Cl. CPC G06F 9/3885; G06T 1/20; G06T 15/005

(57) ABSTRACT

A computing core for rendering an image computing core comprises a position encoding logic and a plurality of pipeline logics connected in series in a pipeline. The position encoding logic is configured to transform coordinates and directions of sampling points corresponding to a portion of the image into high dimensional representations. The plurality of pipeline logics are configured to output, based on the high dimensional representation of the coordinates and the high dimensional representation of the directions, intensity and color values of pixels corresponding to the portion of the image in one pipeline cycle. The plurality of pipeline logics are configured to run in parallel.

### CROSS REFERENCE TO RELATED APPLICATIONS

This application is a continuation application of International Application No. PCT/CN2021/136922, filed on Dec. 9, 2021, the entire contents of which are incorporated herein by reference.

### TECHNICAL FIELD

The present invention generally relates to image processing. More particularly, the present invention relates to a computing system for performing real-time neural network-based image rendering.

### BACKGROUND

Image processing techniques using machine learning models, such as neural networks, have been developed for rendering high-quality images. For example, neural radiance field techniques based on neural networks have been recently developed to synthesize photorealistic images from novel viewpoints (i.e., perspectives). For instance, a neural radiance field of an object can be encoded into a neural network based on a training dataset comprising images depicting the object from various viewpoints. Once the neural network is trained, intensity and color values of pixels of an image of the object can be obtained, and the image can be rendered. In general, conventional neural radiance field-based image rendering techniques have their limitations. For example, due to large amount of data that needs to be processed by current implementations of neural radiance field-based image processing systems, real-time image rendering is often not practical. As such, better solutions are needed.

### SUMMARY

Described herein is a computing core for rendering an image. The computing core can comprise a position encoding logic and a plurality of pipeline logics connected in series in a pipeline. The position encoding logic can be configured to transform coordinates and directions of sampling points corresponding to a portion of the image into high dimensional representations. The plurality of pipeline logics can be configured to output, based on the high dimensional representation of the coordinates and the high dimensional representation of the directions, intensity and color values of pixels corresponding to the portion of the image in one pipeline cycle. The plurality of pipeline logics can be configured to run in parallel.

In some embodiments, the plurality of pipeline logics can comprise a first pipeline logic, a second pipeline logic, and a third pipeline logic. The first pipeline logic can be configured to receive the high dimensional representation of the coordinates, the second pipeline logic can be configured to receive the high dimensional representation of the coordinates and an output of the first pipeline logic, and the third pipeline logic can be configured to receive the high dimensional representation of the directions and an output of the second pipeline logic, and output intensity and color values of the pixels corresponding to the portion of the image.

In some embodiments, the position encoding logic can be configured to execute Fourier feature mapping to transform the coordinates and the directions of the sampling points to the high dimensional representation of the coordinates and the high dimensional representation of the directions, respectively.

In some embodiments, a first memory and a second memory can be coupled to the position encoding logic. The first memory can be configured to store the high dimensional representation of the coordinates and the second memory can be configured to store the high dimensional representation of the directions. The first memory and the second memory can be synchronous random access memory modules.

In some embodiments, the first memory and the second memory can be first-in-first-out memories. The first memory can be configured to store the high dimensional representation of the coordinates and the second memory can be configured to store the high dimensional representation of the directions.

In some embodiments, the plurality of pipeline logics can be configured to encode a machine learning model based on a neural network. Each of the plurality of pipeline logics can be configured to perform computations associated with particular neural layers of the neural network.

In some embodiments, the neural network can be a neural radiance field.

In some embodiments, the neural radiance field can be encoded through the neural layers of the neural network.

In some embodiments, the neural network can comprise ten neural layers.

In some embodiments, the first pipeline logic can be configured to execute computations associated with first four neural layers of the neural network based on the high dimensional representation of the coordinates to output a first positional encoding representation.

In some embodiments, the second pipeline logic can be configured to execute computations associated with next three neural layers of the neural network based on a concatenation of the high dimensional representation of the coordinates and the first positional encoding representation to output a second positional encoding representation.

In some embodiments, the third pipeline logic can be configured to execute computations associated with final three neural layers of the neural network based on a concatenation of the high dimensional representation of the directions and the second positional encoding representation to output the intensity and color values of the pixels.

In some embodiments, the high dimensional representation of the coordinates can comprise 63 dimensions and the high dimensional representation of the directions can comprise 27 dimensions.

In some embodiments, each of the plurality of pipeline logics can comprise a multiply-accumulate array.

Described herein is a computing system comprising a plurality of the computing cores. The plurality of the computing cores can be configured to render a portion of an image in parallel.

Described herein is a computer-implemented image rendering method. A computing system can be configured to divide an image to be rendered into rows of image portions. The computing system can obtain, for each image portion, coordinates and directions of sampling point corresponding to pixels of the image portion. The computing system can transform, for each image portion, the coordinates and directions into high dimensional representations. The computing system can determine, through a computing core, intensity and color values of the pixels. The computing system can reconstruct the image based on intensity and color values of pixels of the rows of image portions.

In some embodiments, the coordinates and directions of the sampling points can be transformed into the high dimensional representations based on a Fourier feature mapping technique.

In some embodiments, the computing core can be configured to execute computations associated with a machine learning model encoded with a neural radiance field and the computing core is associated with a row of image portions.

In some embodiments, the machine learning model can be based on a neural network.

These and other features of the apparatuses, systems, methods, and non-transitory computer-readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the invention are utilized, and the accompanying drawings of which:

FIG. 1 illustrates a machine learning model, according to various embodiments of the present disclosure.

FIG. 2 illustrates a computing core of a computing system configured for image rendering, according to various embodiments of the present disclosure.

FIG. 3A illustrates a processor architecture of a computing core of a computing system configured for image rendering, according to various embodiments of the present disclosure.

FIG. 3B illustrates an image rendering environment in which a plurality of computing cores of a computing system is configured to parallelly render images, according to various embodiments of the present disclosure.

FIG. 4 illustrates a computing component that includes one or more hardware processors and a machine-readable storage media storing a set of machine-readable/machine-executable instructions that, when executed, cause the hardware processor(s) to perform a method, according to various embodiments of the present disclosure.

FIG. 5 is a block diagram that illustrates a computer system upon which any of various embodiments described herein may be implemented.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION OF THE EMBODIMENTS

Provided herein are technical solutions that address problems arising from conventional methods of image rendering as discussed above. In various embodiments, a computing system can be configured to render images based on neural radiance field techniques. The computing system can comprise a plurality of computing cores (or processing cores). The plurality of computing cores can be configured to parallelly render images through a machine learning model, such as a neural network. By taking advantage of parallel processing, the plurality of computing cores can accelerate computations associated with the machine learning model. Such a parallel computer architecture is desirable because each of the plurality of computing cores can be configured to process a particular portion of an image through the machine learning model. For example, assume that the machine learning model can be implemented with a neural network. In this example, each computing core can be dedicated to computations associated with the neural network to render a portion of an image. These and other features of the technical inventions are discussed herein.

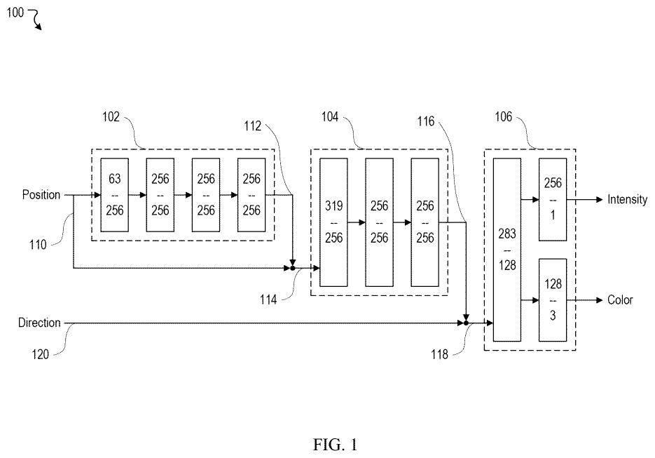

FIG. 1 illustrates a machine learning model 100, according to various embodiments of the present disclosure. In various embodiments, the machine learning model 100 can be based on a neural network (e.g., a fully connected neural network or a multilayer perceptron). The machine learning model 100 can encode a three-dimensional imaging space (e.g., a neural radiance field). The three-dimensional imaging space can be configured to output intensity and color values of sampling points in the three-dimensional imaging space based on input vectors. In some embodiments, the input vectors can include at least a first input vector and a second input vector. The first input vector to be inputted to the machine learning model 100 can be associated with coordinates of the sampling points and the second input vector to the machine learning model 100 can be associated with directions of the sampling points. As shown in FIG. 1, in some embodiments, layers (i.e., portions) of the machine learning model 100 can be divided or grouped into pipeline stages. Each pipeline stage can be dedicated to performing a particular computational task. For example, layers of the machine learning model 100 can be divided or grouped into one or more pipeline stages with each pipeline stage dedicated to performing a particular image rendering task. As shown in FIG. 1, in some embodiments, the machine learning model 100 can be divided or grouped into a first pipeline stage 102, a second pipeline stage 104, and a third pipeline stage 106. Each of these pipeline stages will be discussed in further detail below.

In some embodiments, the first pipeline stage 102 can be configured to perform image rendering tasks relating to transforming positional encoding of sampling points in the three-dimensional imaging space. The first pipeline stage 102 can take in a position input vector 110 (e.g. “Position”) comprising 63 dimensions of spatial information (e.g., coordinates) and process the position input vector 110 through layers (e.g., neural layers) of the first pipeline stage 102. Based on the position input vector 110, the first pipeline stage 102 can output a first output vector 112 (e.g., a positional encoding vector representation), as part of an input, to the second pipeline stage 104. In some embodiments, the first output vector 112 can comprise 256 dimensions. In this regard, the first pipeline stage 102 can transform the position input vector 110 from 63 dimensions into a vector representation having 256 dimensions or features. The first output vector 112 can be concatenated with the position input vector 110 prior to being inputted into the second pipeline stage 104. As shown in FIG. 1, in some embodiments, the first pipeline stage 102 can comprise four layers. Each of the four layers can comprise any suitable number of neurons (e.g., perceptrons). Although the first pipeline stage 102 is described as having four layers, the first pipeline stage 102 is not limited to just four layers. In various embodiments, the first pipeline stage 102 can be adapted to have any number of layers. For example, in some embodiments, the first pipeline stage 102 can comprise ten layers with differing numbers of neurons in each of the ten layers.

In some embodiments, the second pipeline stage 104 can be configured to perform image rendering tasks relating to processing of transformed positional encoding of sampling points of the three-dimensional imaging space. The second pipeline stage 104 can take in a first input vector 114 that is a concatenation of the position input vector 110 and the first output vector 112. In this regard, the first input vector 114 can have 319 dimensions or features (i.e., 63 dimensions of the position input vector 110 plus 256 dimensions of the first output vector 112). Based on the first input vector 114, the second pipeline stage 104 can output a second output vector 116 (i.e., a positional encoding vector representation), as part of an input, to the third pipeline stage 106. In some embodiments, the second output vector 116 outputted by the second pipeline stage 106 can comprise 256 dimensions or features. In this regard, the second pipeline stage 104 reduces the dimension of the first input vector 114 from 319 dimensions to 256 dimensions or features. As shown in FIG. 1, in some embodiments, the second pipeline stage 104 can comprise three layers. Each of the three layers can comprise any suitable number of neurons (e.g., perceptrons).

In some embodiments, the third pipeline stage 106 can be configured to output intensity and color values of sampling points of the three-dimensional imaging space (e.g., “Color” and “Intensity”). The third pipeline stage 106 can be configured to output the intensity and color values based on positional encoding and directions of sampling points. The third pipeline stage 106 can take in a second input vector 118 that is a concatenation of a direction vector 120 and the second output vector 116. Based on the second input vector 118, the third pipeline stage 106 can output the intensity and color values of the sampling points. In some embodiments, the direction vector 120 can be associated with camera rays of pixels of an image to be rendered. The camera rays are generated from a perspective of the image. In general, the camera rays can provide information relating to directions of sampling points in the three-dimensional imaging space that correspond to the pixels of the image. In this way, the pixels can be adapted to have intensity and color values of the sampling points. In some embodiments, the direction vector 120 can comprise 27 dimensions or features. When the direction vector 120 is concatenated with the second output vector 116, the resulting vector (i.e., the second input vector 118) has 283 dimensions or features. As shown in FIG. 1, in some embodiments, the third pipeline stage 106 can comprise three layers. Each of the three layers can comprise any suitable number of neurons (e.g., perceptrons). As shown in FIG. 1, the first layer of the third pipeline stage 106 can be configured to receive and process the second input vector 118. The processed vector can be concurrently inputted into the second layer and the third layer of the third pipeline stage 106. Based on the processed vector, the second layer can output intensity values of sampling points (e.g., “Intensity”) and the third layer can output corresponding color values of the sampling points (e.g., “Color”). The intensity values and color values of the sampling points can be composited such that pixel color can be determined. In some embodiments, the intensity values of the sampling points can be provided as vector representations comprising one dimension and the color values of the sampling points can be provided as vector representations comprising three dimensions.

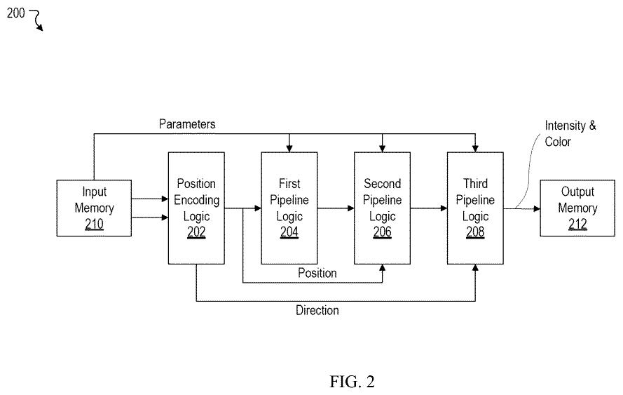

FIG. 2 illustrates a computing core 200 of a computing system configured for image rendering, according to various embodiments of the present disclosure. The computing system can be configured to perform image rendering tasks. As shown in FIG. 2, in some embodiments, the computing core 200 can comprise a position encoding logic 202, a first pipeline logic 204, a second pipeline logic 206, and a third pipeline logic 208. In some embodiments, data processing performed by the first pipeline stage 102, the second pipeline stage 104, and the third pipeline stage 106 of FIG. 1 can be performed by the computing core 200 through the first pipeline logic 204, the second pipeline logic 206, and the third pipeline logic 208, respectively. In some embodiments, the position encoding logic 202 can be configured to determine or map coordinates, (x, y, z) and directions, (θ, ε), of sampling points. The coordinates and the directions of the sampling points can be determined based on pixels of an image to be rendered. For example, the position encoding logic 202 can determine coordinates and directions of sampling points corresponding to the pixels of the image based on camera rays projecting from the pixels. The position encoding logic 202 can transform dimensions of the coordinates and the directions of the sampling points, from their original dimensions, to high dimensions. For example, in some embodiments, the position encoding logic 202 can use Fourier feature mapping techniques to transform coordinates (x, y, z) and directions (θ, ε) of sampling points from dimensions of three and two to dimensions of 63 and 27, respectively. In this way, position and direction information of the sampling points can be encoded in high dimensions, thereby enabling images can be rendered in higher fidelity. The position encoding logic 202 can provide the high dimension coordinates and directions of the sampling points to the first pipeline logic 204, the second pipeline logic 206, and the third pipeline logic 208 for further processing.

Image rendering tasks performed by the first pipeline logic 204, the second pipeline logic 206, and the third pipeline logic 208 have already been discussed in reference with FIG. 1 above, therefore it will not be repeated here. For example, the position encoding logic 202 can provide high dimension coordinates of sampling points corresponding to pixels of an image to be rendered to the first pipeline logic 204 and the second pipeline logic 206. The position encoding logic 202 can provide high dimension directions of the sampling points to the third pipeline logic 208. Through the first pipeline logic 204, the second pipeline logic 206, and the third pipeline logic 208, intensity and color values of the sampling points can be determined and subsequently be used to render the image. In various embodiments, the first pipeline logic 204, the second pipeline logic 206, and the third pipeline logic 208 can be configured to perform matrix calculations associated with a machine learning model, such as a neural network. As shown in FIG. 2, in some embodiments, the computing core 200 can further include an input memory 210 and an output memory 212. In general, the input memory 210 and the output memory 212 can be implemented using any suitable types of memory or memory data structure. In one particular implementation, the input memory 210 and the output memory 212 can be first-in-first-out (FIFO) memories (e.g., data buffers). In a FIFO memory, as its name implies, data that comes into the FIFO memory first is outputted first. In some embodiments, the input memory 210 can be configured to stored parameters (e.g., weights) associated with layers of the machine learning model, such as neural layers of the neural network. For example, the input memory 210 can be configured to store parameters used to tune neurons of the first pipeline stage 102, the second pipeline stage 104, and the third pipeline stage 106 of FIG. 1. The parameters can be loaded from the input memory 210 to the first pipeline logic 204, the second pipeline logic 206, and the third pipeline logic 208, prior to the first pipeline logic 204, the second pipeline logic 206, and the third pipeline logic 208 performing matrix calculations relating to the machine learning model. In some embodiments, the input memory 210 can be further configured to store coordinates and directions of sampling points obtained from an off-chip memory accessible by the input memory 210. In some embodiments, the output memory 212 can be configured to store intensity and color values of sampling points as generated by the third pipeline logic 208. These intensity and color values can be subsequently accessed by other logics or processors of the computing system for image rendering.

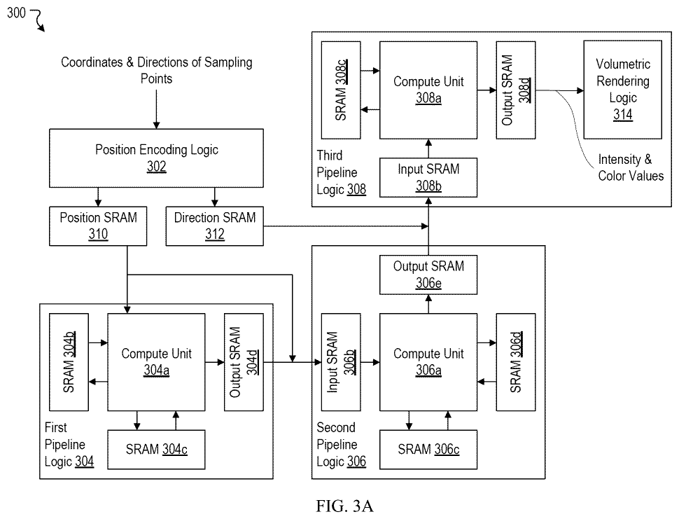

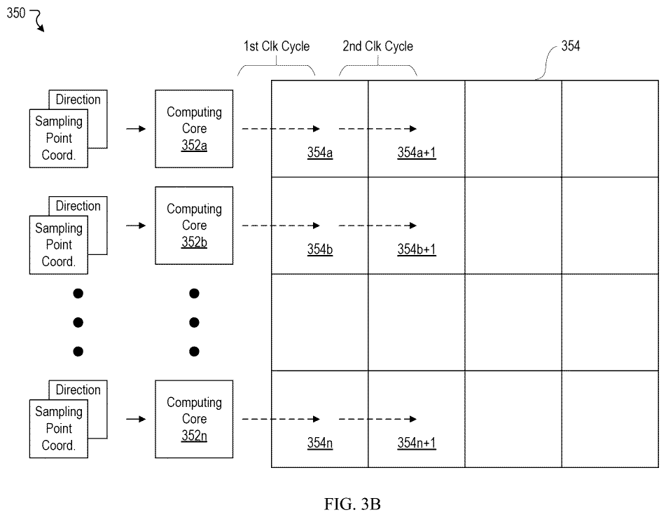

FIG. 3A illustrates a processor architecture 300 of a computing core of a computing system configured for image rendering, according to various embodiments of the present disclosure. The computing system can instruct the computing core to perform image rendering tasks. In some embodiments, the computing core 200 of FIG. 2 can be implemented through the processor architecture 300. As shown in FIG. 3A, in some embodiments, the processor architecture 300 can include a position encoding logic 302 coupled to a first pipeline logic 304, a second pipeline logic 306, and a third pipeline logic 308 through a position synchronous random access memory 310 (“Position SRAM”) and a direction synchronous random access memory 312 (“Direction SRAM”). As discussed in relation to FIG. 2 above, the position encoding logic 302 can obtain parameters (i.e., network parameters) associated with a machine learning model (i.e., neural network) that is encoded into the first pipeline logic 304, the second pipeline logic 306, and the third pipeline logic 308. Based on the parameters, the first pipeline logic 304, the second pipeline logic 306, and the third pipeline logic 308 can perform matrix calculations associated with the machine learning model. In various embodiments, the parameters associated with the machine learning model can include quantization information, biases, and weights associated with a rendering scene. The position encoding logic 302 can provide (i.e., transmit) the parameters to the first pipeline logic 304, the second pipeline logic 306, and the third pipeline logic 308 prior to execution of the matrix calculations.

In some embodiments, the position encoding logic 302 can be configured to transform coordinates and directions of sampling points to high dimensional representations. For example, the position encoding logic 302 can transform the coordinates of the sampling points from dimensions of three to a vector representation comprising 62 dimensions. As another example, the position encoding logic 302 can transform the directions of the sampling points from dimensions of two to a vector representation comprising 27 dimensions. Once transformed, the position encoding logic 302 can store the high dimensional representation of the coordinates and the high dimensional representation of the directions in the position SRAM 310 and the direction SRAM 312, respectively.

In some embodiments, the position SRAM 310 can be configured to temporarily store high dimensional representations of coordinates of sampling points corresponding to pixels of an image to be rendered. The high dimensional representations of the coordinates can be later accessed by the first pipeline logic 304 and the second pipeline logic 306 for further processing. In some embodiments, the direction SRAM 312 can be configured to temporarily store high dimensional representations of directions of sampling points corresponding to pixels of an image to be rendered. The high dimensional representations of the directions can be later accessed by the third pipeline logic 308, along with an output of the second pipeline logic 306, for processing intensity and color values of the sampling points.

In some embodiments, the first pipeline logic 304 can comprise a compute unit 304a communicatively coupled to SRAMs 304b, 304c and an output SRAM 304d. In various embodiments, the compute unit 304a can include at least one multiply-accumulate (MAC) array. The MAC array is a logic that can be configured or programmed to compute a product of two numbers and add the resulting product to an accumulator. In general, the MAC array can compute in full integer values or, in some cases, in floating-point values. Many variations are possible. In some embodiments, the compute unit 304a can be configured to access the high dimensional representations of the coordinates stored in the position SRAM 310 and perform calculations (i.e., neural calculations) associated with a portion of a machine learning model (i.e., a neural network) encoded by the first pipeline logic 304. As discussed in relation to FIG. 1 and FIG. 2 above, in some embodiments, the machine learning model can be implemented as a neural network and the first pipeline logic 304 can execute a portion of neural layers of the neural network. In such embodiments, as the first pipeline logic 304 can process the high dimensional representations of the coordinates through layers of the portion of the neural layers of the neural network through clock cycles of the computing core. In some embodiments, the first pipeline logic 304 can instruct the compute unit 304a to alternatively store data between SRAMs 304b, 304c in a “ping-pong” configuration. For example, consider the first pipeline stage 102 of FIG. 1. Assume, in this example, the first pipeline logic 304 is configured to execute the four neural layers of the first pipeline stage 102. In this example, as the compute unit 304a processes the high dimensional representations of the coordinates through the first neural layer of the first pipeline stage 102, the compute unit 304a stores first resulting data to the SRAM 304b. The compute unit 304a then accesses the first resulting data stored in the SRAM 304b and processes the first resulting data through the second neural layer of the first pipeline stage 102. Upon completion, the compute unit 304a stores second resulting data to the SRAM 304c. The compute unit 304a then accesses the second resulting data stored in the SRAM 304c and processes the second resulting data through the third neural layer of the first pipeline stage 102. The compute unit 304a then stores third resulting data to the SRAM 304b, and so on. This “ping-ponging” of data storage between the SRAMs 304b and 304c continues until the high dimensional representations of the coordinates are processed through all of the neural layers of the first pipeline stage 102, at which point, the final resulting data is stored in the output SRAM 340d to be accessed by the second pipeline logic 306.

In some embodiments, the second pipeline logic 306 can comprise a compute unit 306a communicatively coupled to an input SRAM 306b, SRAMs 306c, 306d, and an output SRAM 306e. Similar to the first pipeline logic 304, in various embodiments, the compute unit 306a can include at least one multiply-accumulate (MAC) array. In some embodiments, the second pipeline logic 306 can be configured to access data stored in the output SRAM 304d of the first pipeline logic 304 and concatenated this data with the high dimensional representations of the coordinates stored in the position SRAM 310 prior to storing the concatenated data in the input SRAM 306b. The compute unit 306a can perform calculations (i.e., neural calculations) associated with a portion of the machine learning model executed by the second pipeline logic 306 based on the concatenated data through clock cycles of the computing core. Similar to the SRAMs 304b, 304c of the first pipeline logic 304, the SRAMs 306c, 306d can be configured in a ping-pong configuration to temporarily store resulting data as the concatenated data is processed through layers of the machine learning model (i.e., neural layers of the neural network) by the second pipeline logic 306. Upon completion, the compute unit 306a can store the resulting data in the output SRAM 306e to be accessed by the third pipeline logic 308.

In some embodiments, the third pipeline logic 308 can comprise a compute unit 308a communicatively coupled to an input SRAM 308b, a SRAM 308c, and an output SRAM 308d. Similar to the first pipeline logic 304 and the second pipeline logic 306, in various embodiments, the compute unit 308a can include at least one multiply-accumulate (MAC) array. In some embodiments, the third pipeline logic 308 can be configured to access data stored in the output SRAM 306e of the second pipeline logic 306 and concatenated this data with the high dimensional representations of the directions stored in the direction SRAM 312 prior to storing the concatenated data in the input SRAM 308b. The compute unit 308a can perform calculations (i.e., neural calculations) associated with a portion of the machine learning model executed by the third pipeline logic 308 based on the concatenated data through clock cycles of the computing core. The SRAM 308c can be configured to temporarily store resulting data as the concatenated data is processed through layers of the machine learning model (i.e., neural layers of the neural network) by the third pipeline logic 308. Upon completion of data processing, the compute unit 308a can output and store intensity and color values of sampling points corresponding to pixels of an image to be rendered in the output SRAM 308d. The intensity and color values can be later accessed to render the image.

In some embodiments, as shown in FIG. 3A, the third pipeline logic 308 can further include a volumetric rendering logic 314 coupled to the output SRAM 308d of the third pipeline logic 308. The volumetric rendering logic 314 can access intensity and color values stored in the output SRAM 308d to render an image. For example, the volumetric rendering logic 314 can reconstruct an image by piecing together, pixel-by-pixel, intensity and color values of pixels making up the image. In general, a speed at which the computing core represented by the computer architecture 300 can render an image is limited by data pathways from the position encoding logic 302, the first pipeline logic 304, the second pipeline logic 306, and the third pipeline logic 308. As such, in this particular processor architecture 300, the third pipeline logic 308 can be configured to have a number of layers that is less than numbers of layers of the first pipeline logic 304 and the second pipeline logic 306. By parallelly processing high dimensional representations of coordinates and directions of sampling points, the computing core can optimally output intensity and color values of the sampling points. In some embodiments, the volumetric rendering logic 314 can be integrated into the third pipeline logic 308. Such embodiments are feasible because, comparing to time it takes to process data through the first pipeline logic 304, the second pipeline logic 306, and the third pipeline logic 308, time it takes to render an image is much less. Therefore, such embodiments do not affect the overall speed of the computing core in rendering images.

FIG. 3B illustrates an image rendering environment 350 in which a plurality of computing cores 352a-352n+1 of a computing system is configured to parallelly render images, according to various embodiments of the present disclosure. As shown in FIG. 3B, the image rendering environment 350 can include an image 354 to be rendered by the computing system. The image 354 can be divided into a plurality of equal image portions 354a-354n+1. The plurality of image portions 354a-354n+1 can be divided into rows of image portions. Each row of image portion can be associated with a computing core of the plurality of computing cores 352a-352n and each computing core can be configured to render a row of image portions of the image 354 that it is associated with. For example, as shown in FIG. 3B, the computing core 352a can be configured to render a row of image portions that starts with the image portion 354a (i.e., an upper left portion of the image 354), the computing core 352b can be configured to render a row of image portions that starts with the image portion 354b, and the computing core 352n can be configured to render a row of image portions that starts with the image portion 354n (i.e., a lower left portion of the image 354), and so on. As discussed in relation to FIG. 3A above, in various embodiments, a computing core can be configured to render a portion of an image by inputting (e.g., querying) coordinates and directions of sampling point corresponding to pixels of the portion of the image through pipeline logics (e.g., the first pipeline logic 304, the second pipeline logic 306, and the third pipeline logic 308 of FIG. 3A) to obtain intensity and color values of the pixels. By architecting the computing system with multiple computing cores, the computing system can render images in real-time or near real-time through parallel processing. For example, in a first pipeline cycle (e.g., a clock cycle), the computing core 352a can be configured to render the image portion 354a, the computing core 352b can be configured to render the image portion 354b, and the computing core 352n can be configured to render the image portion 354n. In a second pipeline cycle, the computing core 352a can be configured to render the image portion 354a+1, the computing core 352b can be configured to render the image portion 354b+1, and the computing core 352n can be configured to render the image portion 354n+1. In this way, the computing system can take advantage of parallel processing to render the image 354. Unlike a conventional computing system with a single computing core, the computing system of the present disclosure uses parallel processing, through the plurality of computing cores 352a-352n, to render images. In this way, an amount of data processing (e.g., image rendering) performed by each computing core is reduced, thereby significantly accelerating a rendering speed of the computing system. Furthermore, because the computing system can take advantage of parallel processing, the plurality of computing cores 352a-352n can simultaneously execute computations associated with the pipeline logics. The plurality of image portions 354a-354n+1 can be later combined into the image 354.

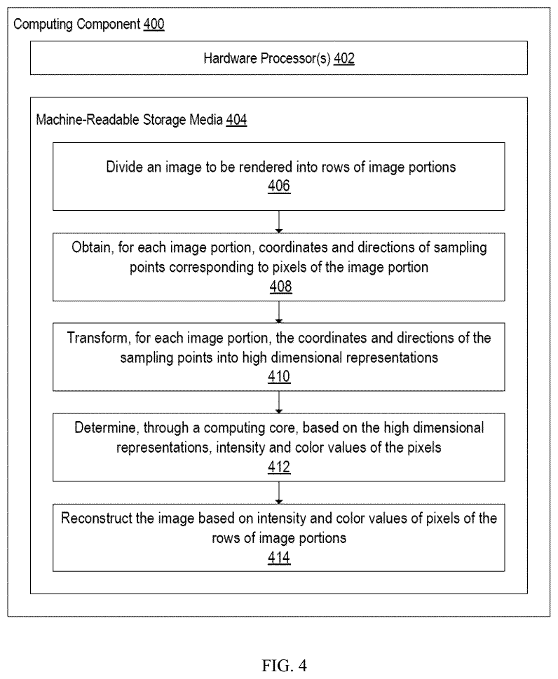

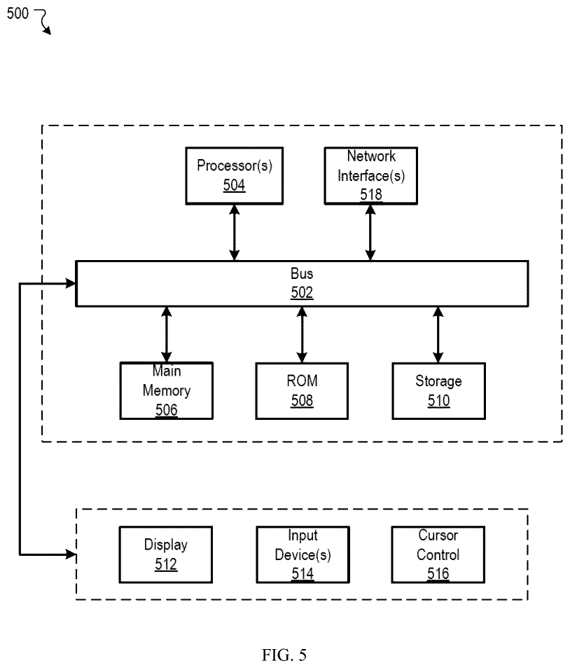

FIG. 4 illustrates a computing component 400 that includes one or more hardware processors 402 and a machine-readable storage media 404 storing a set of machine-readable/machine-executable instructions that, when executed, cause the hardware processor(s) 402 to perform a method, according to various embodiments of the present disclosure. The computing component 400 may be, for example, the computing system 500 of FIG. 5. The hardware processors 402 may include, for example, the processor(s) 504 of FIG. 5 or any other processing unit described herein. The machine-readable storage media 404 may include the main memory 506, the read-only memory (ROM) 508, the storage 510 of FIG. 5, and/or any other suitable machine-readable storage media described herein.

At block 406, the processor 402 can divide an image to be rendered into rows of image portions.

At block 408, the processor 402 can obtain, for each image portion, coordinates and directions of sampling points corresponding to pixels of the image portion.

At block 410, the processor 402 can transform, for each image portion, the coordinates and directions of the sampling points into high dimensional representations.

At block 412, the processor 402 can determine, through a computing core, based on the high dimensional representations, intensity and color values of the pixels.

At block 414, the processor 402 can reconstruct the image based on intensity and color values of pixels of the rows of image portions

The techniques described herein, for example, are implemented by one or more special-purpose computing devices. The special-purpose computing devices may be hard-wired to perform the techniques, or may include circuitry or digital electronic devices such as one or more application-specific integrated circuits (ASICs) or field programmable gate arrays (FPGAs) that are persistently programmed to perform the techniques, or may include one or more hardware processors programmed to perform the techniques pursuant to program instructions in firmware, memory, other storage, or a combination.

FIG. 5 is a block diagram that illustrates a computer system 500 upon which any of various embodiments described herein may be implemented. The computer system 500 includes a bus 502 or other communication mechanism for communicating information, one or more hardware processors 504 coupled with bus 502 for processing information. A description that a device performs a task is intended to mean that one or more of the hardware processor(s) 504 performs.

The computer system 500 also includes a main memory 506, such as a random access memory (RAM), cache and/or other dynamic storage devices, coupled to bus 502 for storing information and instructions to be executed by processor 504. Main memory 506 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions.

The computer system 500 further includes a read only memory (ROM) 508 or other static storage device coupled to bus 502 for storing static information and instructions for processor 504. A storage device 510, such as a magnetic disk, optical disk, or USB thumb drive (Flash drive), etc., is provided and coupled to bus 502 for storing information and instructions.

The computer system 500 may be coupled via bus 502 to output device(s) 512, such as a cathode ray tube (CRT) or LCD display (or touch screen), for displaying information to a computer user. Input device(s) 514, including alphanumeric and other keys, are coupled to bus 502 for communicating information and command selections to processor 504. Another type of user input device is cursor control 516. The computer system 500 also includes a communication interface 518 coupled to bus 502.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Additionally, the singular forms “a,” “an” and “the” include plural referents unless the context clearly dictates otherwise. The phrases “at least one of,” “at least one selected from the group of,” or “at least one selected from the group consisting of,” and the like are to be interpreted in the disjunctive (e.g., not to be interpreted as at least one of A and at least one of B).

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiment.

A component being implemented as another component may be construed as the component being operated in a same or similar manner as the another component, and/or comprising same or similar features, characteristics, and parameters as the another component.

What we claim is:

1. A computing core for rendering an image comprising:
a position encoding logic configured to transform coordinates and directions of a plurality of sampling points corresponding to a portion of the image into high dimensional representations; and
a plurality of pipeline logics connected in series in a pipeline, wherein the plurality of pipeline logics are configured to output, based on the high dimensional representation of the coordinates and the high dimensional representation of the directions, intensity and color values of pixels corresponding to the portion of the image in one pipeline cycle, wherein the plurality of the pipeline logics are configured to run in parallel.

2. The computing core according to claim 1, wherein the plurality of pipeline logics comprise a first pipeline logic, a second pipeline logic, and a third pipeline logic, wherein the first pipeline logic is configured to receive the high dimensional representation of the coordinates, the second pipeline logic is configured to receive the high dimensional representation of the coordinates and an output of the first pipeline logic, and the third pipeline logic is configured to receive the high dimensional representation of the directions and an output of the second pipeline logic, and output intensity and color values of the pixels corresponding to the portion of the image.

3. The computing core according to claim 1, wherein the position encoding logic is configured to execute Fourier feature mapping to transform the coordinates and the directions of the sampling points to the high dimensional representation of the coordinates and the high dimensional representation of the directions, respectively.

4. The computing core according to claim 1, further comprising:
a first memory and a second memory coupled to the position encoding logic, wherein the first memory is configured to store the high dimensional representation of the coordinates and the second memory is configured to store the high dimensional representation of the directions, wherein the first memory and the second memory are synchronous random access memory modules.

5. The computing core according to claim 4, wherein the first memory and the second memory are first-in-first-out memories, and wherein the first memory is configured to store the high dimensional representation of the coordinates and the second memory is configured to store the high dimensional representation of the directions.

6. The computing core according to claim 1, wherein the plurality of pipeline logics are configured to encode a machine learning model based on a neural network, and wherein each of the plurality of pipeline logics is configured to perform computations associated with particular neural layers of the neural network.

7. The computing core according to claim 6, wherein the neural network is a neural radiance field.

8. The computing core according to claim 7, wherein the neural radiance field is encoded through the neural layers of the neural network.

9. The computing core according to claim 6, wherein the neural network comprises ten neural layers.

10. The computing core according to claim 9, wherein the first pipeline logic is configured to execute computations associated with first four neural layers of the neural network based on the high dimensional representation of the coordinates to output a first positional encoding representation.

11. The computing core according to claim 10, wherein the second pipeline logic is configured to execute computations associated with next three neural layers of the neural network based on a concatenation of the high dimensional representation of the coordinates and the first positional encoding representation to output a second positional encoding representation.

12. The computing core according to claim 11, wherein the third pipeline logic is configured to execute computations associated with final three neural layers of the neural network based on a concatenation of the high dimensional representation of the directions and the second positional encoding representation to output the intensity and color values of the pixels.

13. The computing core according to claim 1, wherein the high dimensional representation of the coordinates comprises 63 dimensions and the high dimensional representation of the directions comprises 27 dimensions.

14. The computing core according to claim 1, wherein each of the plurality of pipeline logics comprises a multiply-accumulate array.

16. A computing system comprising a plurality of the computing cores of claim 1, wherein the plurality of the computing cores are configured to render a portion of an image in parallel.

17. A computer-implemented image rendering method comprising:
dividing, by a computing system, an image to be rendered into rows of image portions;
obtaining, by the computing system, for each image portion, coordinates and directions of sampling points corresponding to pixels of the image portion;
transforming, by the computing system, for each image portion, the coordinates and directions of the sampling points into high dimensional representations;
determining, by the computing system, through a computing core, based on the high dimensional representations, intensity and color values of the pixels; and
reconstructing, by the computing system, the image based on intensity and color values of pixels of the rows of image portions.

18. The computer-implemented image rendering method according to claim 17, wherein the coordinates and directions of the sampling points are transformed into the high dimensional representations based on a Fourier feature mapping technique.

19. The computer-implemented image rendering method according to claim 17, wherein the computing core is configured to execute computations associated with a machine learning model encoded with a neural radiance field and the computing core is associated with a row of image portions.

20. The computer-implemented image rendering method according to claim 19, wherein the machine learning model is based on a neural network.
